(19) United States
(12) Patent Application Publication
(10) Pub. No.: US 2024/0396147 A1
(43) Pub. Date: Nov. 28, 2024

(54) BATTERY MODULE END CAP

(71) Applicant: JAGUAR LAND ROVER LIMITED, Whitley, Coventry, Warwickshire (GB)

(72) Inventors: Robert TRIGG, Banbury, Oxfordshire (GB); Ruben ARJONA, Coventry, Warwickshire (GB); Ian ROBERTS, Coventry, Warwickshire (GB)

(21) Appl. No.: 18/700,696

(22) PCT Filed: Oct. 19, 2022
(86) PCT No.: PCT/EP2022/079125

§ 371 Date: Apr. 11, 2024

(30) Foreign Application Priority Data
Oct. 21, 2021 (GB) 2115142.8

(51) Int. Cl. H01M 50/244; H01M 50/249; H01M 50/262; H01M 50/507

(52) U.S. Cl. CPC H01M 50/244; H01M 50/249; H01M 50/262; H01M 50/507

(57) ABSTRACT

Disclosed herein are examples of an end cap (100) for a battery module housing of an electric vehicle (800). The end cap (100) comprises an electrically conductive end cap housing (102), configured to connect to an end of a traction battery housing. The end cap (100) comprises an electrically insulating busbar connector housing (104) fixed within the end cap housing (102). The end cap (100) comprises an electrically conductive busbar connector (106) fixed within the busbar connector housing (104). The busbar connector housing (104) is configured to electrically isolate the busbar connector (106) from the end cap housing (102). The busbar connector (106) is configured to connect to a module busbar of a battery module inside the battery module housing, and provide a terminal outside the battery module housing to allow for electrical connection to the module busbar.

### TECHNICAL FIELD

The present invention relates generally to an end cap for a battery module. In particular, but not exclusively, the invention relates to an end cap for use with a battery module used as a vehicle traction battery, for example for a Battery Electric Vehicle (BEV). Aspects of the invention relate to end caps, battery modules, battery packs, vehicles, and methods of forming an end cap.

### BACKGROUND

There has recently been increased interest in providing battery-powered vehicles, which has led to developments in vehicle batteries, in particular vehicle traction battery technology. It is generally desirable for vehicle batteries to provide high energy capacity and peak current output, whilst minimising the size and weight of the battery module and thus the vehicle.

Vehicle traction batteries often comprise one or more modules each containing a plurality of cells. It is generally desirable to package the cells into a battery module densely, so as to maximise the energy and current capacity that can be provided within a given packaging volume.

As well as aiming for desirable electrical properties and packaging space requirements, structural integrity of the battery packs is important to consider, not least in view of their use in vehicles which, by their nature, vibrate and may incur shock impacts through use (e.g. if in a collision, driving over rough terrain or over speed bumps). Furthermore, it is also important to ensure the connection to the battery cells in a battery module from outside the battery module is electrically isolated from any surrounding electrically conducting elements which may undesirably form a short circuit.

Thus, there is a need to provide reliable and structurally sound battery modules and battery packs for electric vehicles.

### SUMMARY

According to an aspect of this disclosure, there is provided an end cap for a battery module housing of an electric vehicle, the end cap comprising: an electrically conductive end cap housing, the end cap housing configured to connect to an end of a traction battery housing; an electrically insulating busbar connector housing fixed within the end cap housing; and an electrically conductive busbar connector fixed within the busbar connector housing, the busbar connector housing configured to electrically isolate the busbar connector from the end cap housing, the busbar connector configured to connect to a module busbar of a battery module inside the battery module housing and provide a terminal outside the battery module housing to allow for electrical connection to the module busbar.

Advantageously, a rigid end cap for a battery module may be readily manufactured, providing good structural integrity as required for use in a vehicle. Electrical connections may be made easily and securely to elements within the battery module via the busbar connector end cap. The presence of a rigid electrically isolating busbar connector housing between the busbar connector and the end cap housing advantageously allows for an end cap housing to be made from any suitable rigid material, such as aluminium, and any suitable manufacturing method, to provide a structurally strong framework while ensuring the busbar connector remains electrically isolated from the battery module housing.

A battery module may comprise an array of electrical cells (e.g. (rechargeable) battery cells, and/or capacitors e.g. supercapacitors, configured to store electrical charge). The busbar connector housing may be rigid. The end cap housing may be rigid.

The busbar connector housing may comprise an overmoulded housing formed by moulding electrically insulating material around an outer edge of the busbar connector, thereby, once the electrically insulating material is set, rigidly fixing the busbar connector in position in the busbar connector housing.

Overmoulding the busbar connector with insulating material to form the busbar connector housing advantageously allows for the busbar connector to be held in a secure tight fit within the busbar housing, thereby contributing to the structural stability of the overall end cap. Overmoulding the edges of the busbar connector also desirably helps ensure electrical isolation of the busbar connector from the end cap housing.

The busbar connector housing may comprise a first housing plate providing an inner plate portion, and a second housing plate providing an outer plate portion, the first and second housing plates configured to fasten together with the busbar connector sandwiched therebetween to rigidly fix the busbar connector in position in the busbar connector housing.

The busbar connector housing may be fixed in the end cap housing by a plurality of posts of the busbar connector housing located in a corresponding plurality of postholes in the end cap housing. Each such posts may be heat staked to fix it in position in its corresponding posthole. Heat staking advantageously provides a simple and reliable way of rigidly fixing the busbar connector housing to the end cap housing.

The end cap may comprise a plurality of electrically conductive busbar connectors fixed in the busbar connector housing, the busbar connector housing configured to electrically isolate the plurality of busbar connectors from each other and from the end cap housing. There may be two busbar connectors.

The busbar connector housing may be formed from plastic. Preferably, the busbar connector housing may be formed of glass fibre filled polypropylene. Such a material advantageously provides good strength, contributing to a structurally sound overall end cap, while being suitable for overmoulding (for fixing the busbar connectors in the busbar connector housing) and suitable for heat staking (for fixing the busbar connector housing to the end cap housing). The end cap housing may be formed of metal. Preferably, the end cap housing may be formed of aluminium, for example die cast aluminium formed using, e.g. high pressure die casting (HPDC). An example specific material may be an EN-AC46500 aluminium alloy (AlSi₉Cu₃ (Fe) (Zn)). Such materials are commonly used in manufacturing, may be machined using readily available techniques, and provide good structural stability while remaining electrically isolated from the busbar connectors by virtue of the busbar connector housing.

The busbar connector may comprise a metal plate configured to be fixed in the busbar connector housing, and a stud protruding from the metal plate configured to provide the terminal outside the traction battery housing to allow for electrical connection to the module busbar. Preferably, the metal plate may comprise aluminium, because this allows for a lightweight component which may be readily manufactured using high pressure die casting. Preferably, the stud may comprise steel; steel is a standard material used for bolted joints, and allows for the ready manufacture of a thread, because providing thread engagement is preferable for connection to an external connection.

The end cap housing may comprise a plurality of screw holes located to align with a corresponding plurality of screw holes at the end of a traction battery housing. The end cap may be configured to connect to the end of the traction battery housing by being slotted at least partially into the end of the traction battery housing and receive fixing screws through the screw holes at the end of a traction battery housing into the plurality of screw holes of the end cap housing.

The end cap housing may comprise a plurality of channels located from each of the plurality of screw holes of the end cap housing to an outer edge of the end cap housing. The channels may be configured to receive recessed portions of the housing within which the corresponding plurality of screw holes at the end of the traction battery housing are located, thereby allowing for assembly of the end cap in the traction battery housing by sliding the recessed portions of the housing along the corresponding plurality of channels of the end cap housing until the plurality of screw holes of the end cap housing align with the corresponding plurality of screw holes at the end of the traction battery housing.

The plurality of channels may comprises a first channel in a first orientation; and a second channel in a second orientation different to the first orientation. The first channel may be configured to accept a portion of the traction battery housing slid onto the end cap along a first direction with respect to the end cap. The second channel may be configured to accept a second portion of the traction battery housing slid onto the end cap along a second direction with respect to the end cap. The first and second channels may be configured to allow the first and second portions of the traction battery housing to meet after being slid onto the end cap to form a traction battery and end cap assembly.

Advantageously, by providing channels aligned in different directions, a strong housing and end cap assembly may be manufactured. Forces acting to separate the housing from the end cap in one direction along a channel direction are unlikely to cause such a separation because another portion of the housing is slotted into the end cap from a different direction.

In a further aspect there is provided a battery module for an electric vehicle, the battery module comprising: any end cap disclosed herein; a housing, wherein the end cap is located at an end portion of the housing; and a battery within the housing, wherein a module busbar of the battery is electrically connected inside the housing to the busbar connector.

In a further aspect there is provided a battery pack comprising a plurality of battery modules as disclosed herein.

In a further aspect there is provided a vehicle comprising any end cap disclosed herein, any battery module disclosed herein, or any battery pack disclosed herein.

In a further aspect there is provided a method of forming an end cap for a traction battery housing of an electric vehicle. The method comprises:
forming an electrically conductive busbar connector, the busbar connector configured to connect to a module busbar of a traction battery within a traction battery housing and provide a terminal outside the traction battery housing to allow for electrical connection to the module busbar;
forming an electrically insulating busbar connector housing with the busbar connection fixed therein;
forming a rigid, electrically conductive, end cap housing, the end cap housing configured to be located at and connect to an end of a traction battery housing; and
fitting the busbar connector housing and busbar connector fixed therein into the end cap housing; the busbar connector housing electrically isolating the busbar connector from the end cap housing.

Forming an electrically insulating busbar connector housing around the busbar connector may comprise: overmoulding electrically insulating material around an outer edge of the busbar connector to form the inner plate portion and the outer plate portion; and setting the electrically insulating material to rigidly fix the busbar connector in position in the busbar connector housing.

Forming an electrically insulating busbar connector housing around the busbar connector may comprise: forming a first housing plate providing an inner plate portion of the busbar connector housing; forming a second housing plate providing an outer plate portion of the busbar connector housing; locating the busbar connector between the first and second housing plates; and fastening together the first and second housing plates with the busbar connector sandwiched therebetween to rigidly fix the busbar connector in position in the busbar connector housing.

Fitting the busbar connector housing and module busbar connected housed therein into the end cap housing may comprise: locating a plurality of posts of the busbar connector housing in a corresponding plurality of postholes in the end cap housing; and heat staking the plurality of posts to fix them in position in their corresponding posthole.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments will now be described by way of example only, with reference to the accompanying figures, in which:

FIG. 1 shows an example end cap according to examples of the present disclosure;

FIGS. 2a and 2b show example busbar connectors according to examples of the present disclosure;

FIGS. 3a-3c shows an example of busbar connectors in a busbar connector housing, according to examples of the present disclosure;

FIG. 4 shows an example end cap housing according to examples of the present disclosure;

FIG. 5 show an example end cap having a heat staked busbar connector housing according to examples of the present disclosure;

FIG. 6 shows an example of a schematic flow of assembly of an example battery module, according to examples of the present disclosure;

FIG. 7 shows a method of forming an end cap for a traction battery housing of an electric vehicle according to examples of the present disclosure; and

FIG. 8 shows an example vehicle according to examples of the present disclosure.

### DETAILED DESCRIPTION

An electric vehicle may be, for example, a battery electric vehicle (BEV), a hybrid electric vehicle (HEV), or a plug-in hybrid electric vehicle (PHEV). A battery module may be considered to be any battery module of a vehicle, for example, a module of a battery, or a battery per se, which is used to start the engine. A traction battery module may be considered to be a module of a traction battery, or a traction battery per se, which is used to drive the vehicle, i.e. power the powertrain to propel the vehicle).

A battery, or battery module, e.g. a traction battery module, for an electric vehicle may comprise an array of electrical cells, e.g. (rechargeable) battery cells, and/or capacitors e.g. supercapacitors, configured to store electrical charge, located in a housing/casing of the battery module. The housing helps to protect the cells and associated electrical connections. The housing may be, for example, a rigid tube, e.g. having a rectangular cross section, in which the cells sit. The housing may be made of metal, e.g. aluminium, and thus electrically conductive. The cells are electrically connected to the outside of the battery module via an electrical connection, e.g. for providing charge to the cells when recharging the battery, or for connecting to another battery module in a battery pack. The electrical connection to the cells may be made via a connection through an end cap of the housing, which is located at the end of the (e.g. tubular) housing.

Improving batteries, for example for use in electric vehicles, is important in view of recent interest in providing cleaner energy solutions. By their nature, vehicles and any battery module/pack housed in the vehicle vibrate in use and may incur shock impacts. It is advantageous for the end cap of a battery module as mentioned above to be structurally rigid (in other words, have high structural integrity) to help provide structural stability to the battery module overall, and also to help protect connections made via the end cap to elements within the battery module housing. Such connections may be electrical connections used to charge, and/or draw charge from, the cells within the housing, sensor connections such as connections to temperature sensor, or connections to control circuitry. Furthermore, it is important to ensure the connection to the battery cells in a battery module, via the end cap, is electrically isolated from any surrounding electrically conducting elements such as a conductive housing, otherwise a short circuit may undesirably form. Examples disclosed here may address problems in the art.

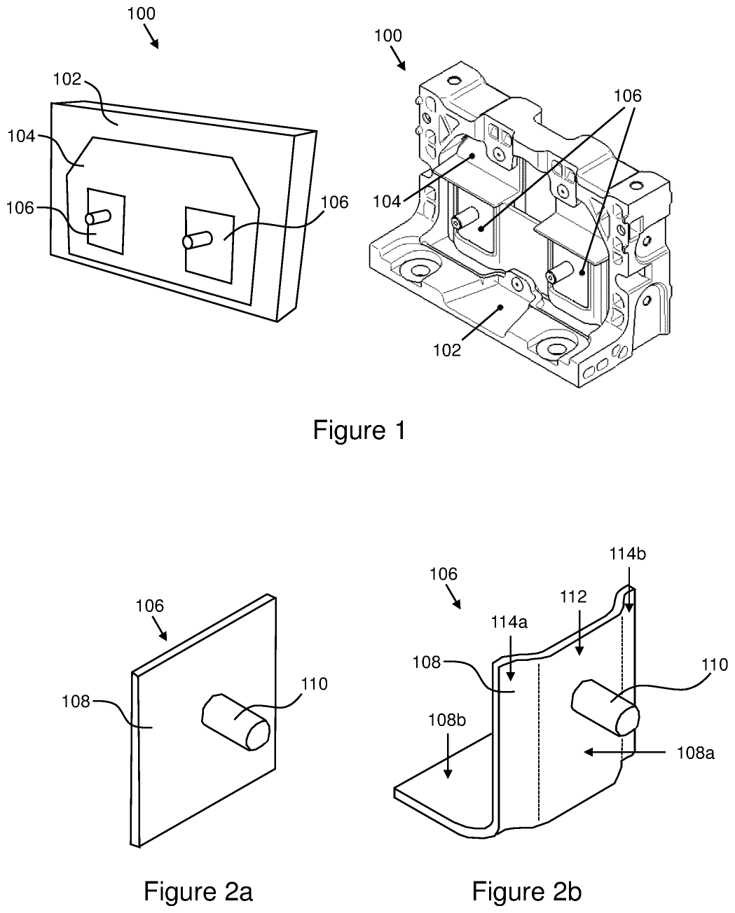

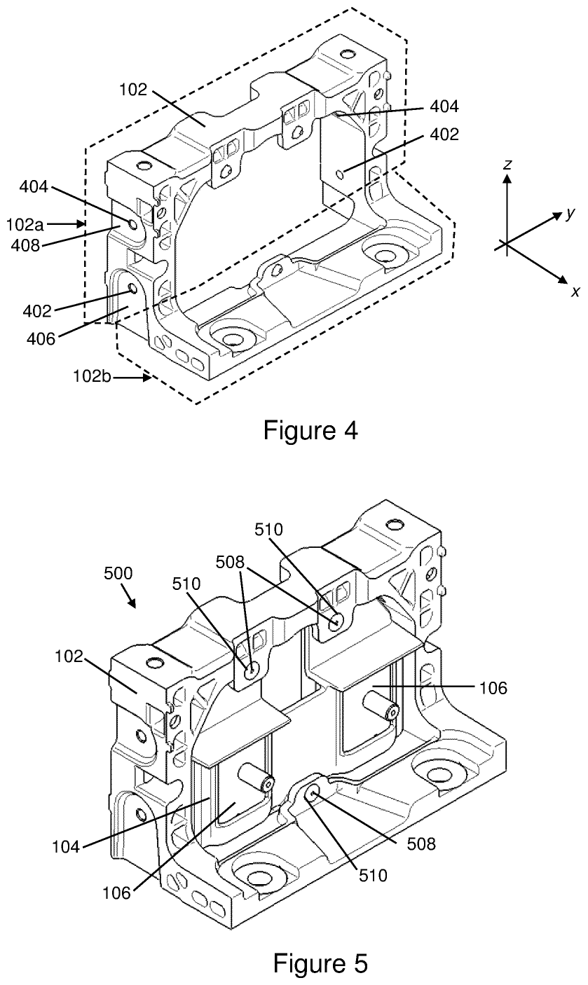

FIG. 1 shows an example end cap 100 for a battery module housing of an electric vehicle. The end cap 100 comprises an electrically conductive end cap housing 102 described further in relation to FIG. 4. The end cap housing 102 is configured to connect to an end of a traction battery housing. The end cap housing 102 may be rigid.

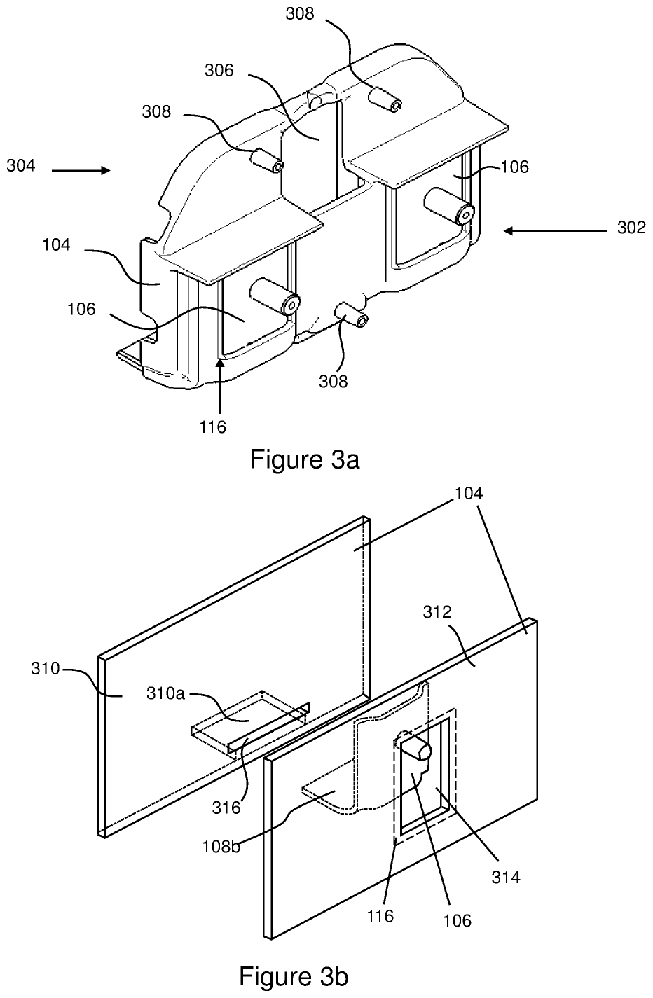

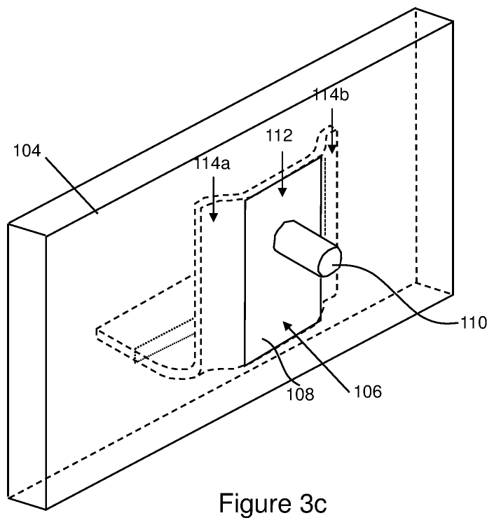

The end cap 100 also comprises an electrically insulating busbar connector housing 104, described further in relation to FIG. 3, fixed within the end cap housing 102. The busbar connector housing 104 may be rigid. The end cap 100 also comprises an electrically conductive busbar connector 106—two are shown in FIG. 1—fixed within the busbar connector housing 104. Busbar connectors 106 are described further in relation to FIGS. 2a-2b.

The busbar connector housing 104 is configured to electrically isolate the busbar connector(s) 106 from the end cap housing 102. A busbar connector 106 is configured to connect to a module busbar of a battery module inside the battery module housing, and provide a terminal outside the battery module housing to allow for electrical connection to the module busbar inside the housing.

FIGS. 2a and 2b show example busbar connectors 106. The busbar connector 106 may, as shown, comprise a metal plate 108 configured to be fixed in the busbar connector housing 104, and a stud 110 protruding from the metal plate 108 configured to provide the terminal outside the traction battery housing to allow for electrical connection to the module busbar. Preferably, the metal plate 108 may comprise aluminium. Preferably, the stud may comprise steel 110. The stud may be screw threaded in some examples to allow for a bolted connection using a nut to attached to the stud acting as the bolt.

FIG. 2a shows a basic busbar connector 106 comprising a flat square or rectangular metal plate 108 and a stud 110. Other shapes of the metal plate are possible, such as a circle. FIG. 2b shows a different shaped busbar connector 106 comprising a shaped metal plate 108 and a stud 110. The shaped metal plate 108 has a front face portion 108a and a bottom portion 108b perpendicular to the front face portion 108a. The bottom portion 108b may help to provide improved structural stability in some end caps, where the bottom portion provides a base on which the busbar connector 106 may be mounted in the busbar connector housing 104. For example, to provide a counter force against forces pushing or pulling the busbar connector on the front face portion of the metal plate 108 which may otherwise cause the busbar connector to tilt. The front face portion in FIG. 2b also has a curved profile with a central plane 112 and offset opposite edge bands 114a, 114b set back from the central plane 112 (i.e. displaced away from the stud 110 on the central plane 112 and coplanar with the plane of the central plane 112). As shown in FIGS. 3a-3c, the busbar connector housing 104 may be formed at least over the front of/around the edge bands 114a, 114b to fix the busbar connector 106 rigidly in place in the busbar connector housing 104.

FIG. 3a shows an example of two busbar connectors 106 in a busbar connector housing 104. The busbar connector housing 104 holds the busbar connectors 106 rigidly in place by forming a lip 116 around the metal plate 108 of the busbar connector 106 around the front 302 of the metal plate 108 and providing a plate of busbar connector material at the back face 304 of the busbar connectors 106. There is an uncovered portion of the busbar connector 106 remaining to allow for electrical connection to elements within the housing. In some examples the busbar connector housing 104 may form a lip around the back of the metal plate 108 rather than a plate covering the rear face of the busbar connector 106. Other configurations are possible whereby busbar connector housing 104 material is present on both the front and rear faces of the busbar connector 106 metal plate 108 to hold it rigidly in place and allow electrical connection to the connector 106 form with in the housing. This is shown in more detail in FIGS. 3b-3c illustrating one busbar connector 106.

The busbar connector housing 104 illustrated in FIG. 3a also comprises an aperture 306 in the housing 104 allowing access to other possible connections to the battery cells. For example, the aperture may provide a cooling spigot clearance allowing a cooling spigot to protrude from the battery module to outside the battery module through the aperture. As another example, a venting path may be provided through the aperture to outside the battery module. Also illustrated in this example are a plurality of posts 308 which may be used to fix the busbar connector housing 104 to the end cap housing 102, as discussed in more detail in relation to FIG. 5.

An end cap may comprise a plurality of electrically conductive busbar connectors 106 fixed in the busbar connector housing 104, and as shown in FIG. 3a, the busbar connector housing 104 may be configured to electrically isolate the plurality of busbar connectors 106 from each other, and from the end cap housing 102. There may be two busbar connectors 106 as shown, but in other examples, there may be only one busbar connector, or there may be more than two busbar connectors in some examples. Furthermore, in some examples, there may be connectors allowing access to other elements than a “busbar” within the battery module which are therefore accessible at the end cap.

As schematically shown in FIG. 3b in an exploded view, the busbar connector housing 104 may comprise a first housing plate 310 providing an inner plate portion; that is, once assembled in the battery module, this portion of the busbar connection housing 104 would lie inside the battery module/be inward facing. The busbar connector housing 104 may also comprise a second housing plate 312 providing an outer plate portion, in that, once assembled in the battery module, this portion of the busbar connection housing 104 would lie on the outer surface battery module/be outward facing. The first and second housing plates 310, 312 are configured to fasten together (e.g. by snap fits, heat staking, ultrasonic welding, rivets) with the busbar connector (or connectors) 106 sandwiched therebetween. In this way the busbar connector(s) 106 are rigidly fixed in position in the busbar connector housing 104.

In this example, the busbar connector 106 has a bottom portion 108b so the first housing plate 310 also comprises a ledge portion 310a on which the bottom portion 108b of the busbar connection 106 can sit and be electrically insulated from any electrically conductive material underneath the bottom portion 108b, for example on the end cap housing 102. Also in this example, the second housing plate 312 comprises a window 314 through which the busbar connector 106 may be accessed, e.g. for electrical connection outside the housing, and the window is dimensioned to provide a lip 116 which abuts at least a portion of the outside edge of the front face 108a of the busbar connector to hold the busbar connector 106 in place in the busbar connector housing 104. The schematic example of FIG. 3b shows a first housing plate 310 which abuts the entire back face of the metal plate of the busbar connector 106 to hold the busbar connector 106 in place in the busbar connector housing. Connection from the busbar connector 106 to the cells inside the battery module may be made via the bottom portion 108b which is accessible via an aperture 316 above the ledge portion 310a. For example, a module busbar of a cell array in the housing may be affixed (e.g. welded) to the bottom portion 108b of the busbar connector 106. In other examples, the first housing plate 310 may comprise a window similar to the window 314 in the second housing plate 312 allowing electrical connection from the busbar connector 106 to the cells in the battery module via the window while also partially overlapping the busbar connector 106, in the same way as the lip 116 on the second connector housing 312 does, to clamp the busbar connector 106 in place in the busbar connector housing 104.

As shown schematically in FIG. 3c the busbar connector housing 104 may comprise an overmoulded housing 104 formed by moulding electrically insulating material around an outer edge of the busbar connector 106. In this example, the moulding is formed at least over edge bands 114a, 114b of the busbar connector 106. In this way, once the electrically insulating material is set/cured, the busbar connector 106 is rigidly fixed in position in the busbar connector housing 104. In some examples similar to that shown in FIG. 3b, at the rear, inner face of the busbar connector housing 102, the electrically insulating material may be present over the entire back face of the busbar connector except the bottom portion 180b to which electrical connection inside the battery module to the busbar connector 106 may be made. In other examples, a different portion of the back of the busbar connector housing 102 may remain exposed. That is, the back of the busbar connector 106 may not be completely covered with electrically insulating material. This allows for electrical connection to the cells within the battery module.

In all of FIGS. 3a-3c. the arrangement of busbar connector(s) 106 and busbar connector housing 104 is to provide electrical isolation of the busbar connector 106 from surrounding housing elements and also provide structural rigidity of the overall end cap, to help maintain good electrical connection between cells and the busbar connector (i.e. from within the battery module, to outside the battery module). This is achieved while allowing for electrical connection to the cells within the housing via a module busbar, for example.

The busbar connector housing 104 may be formed from any suitable electrically insulating material. For example, the busbar connector housing 104 may comprise, or be formed from, plastic. In some examples, the busbar connector housing 104 may be formed of glass fibre filled polypropylene. An example suitable material for the busbar connector housing 104 is 30% glass fibre filled poly-propylene. A specific example of suitable material is Sabic (RTM) Stamax (TM) 30YH570 (PP 30% GF).

FIG. 4 shows an example end cap housing 102. The end cap housing 102 may be provide a structurally stable support structure, and for example may be formed from rigid metal. In some examples, the end cap housing 102 may be formed of aluminium, for example die cast aluminium. The end cap housing 102 may be electrically conductive, without causing a problem with electrically shorting with the busbar connector(s) 106, because the busbar connector(s) 106 are electrically isolated from the end cap housing 102 by the electrically insulating busbar connector housing 104 located between the end cap housing 102 and the busbar connector(s) 106.

The end cap housing 102 in this example has an “L” shaped profile when viewed from the side (along the y direction as illustrated), with an upright frame portion 102a (in the z direction) and a bottom portion 102b extending perpendicularly to the upright portion 102a (in the x direction). The bottom portion 102b is configured to be located on, and be supported by, a bottom plate of a battery module housing to which an end cap, comprising the end cap housing 102, is attached. Other example end cap housings may have a different profile shape, e.g. an upright “I” shaped profile when viewed from the side, i.e. having a rectangular shape when viewed from the front/along the y direction.

The end cap housing 102 in this example comprises a plurality of screw holes 402, 404 located to align with a corresponding plurality of screw holes at the end of a battery housing (e.g. a traction battery housing). In this example a first set 402 and a second set 404 of screw holes are illustrated as discussed below. The end cap, comprising this end cap housing 102, may be configured to connect to the end of the battery housing by being slotted, at least partially, into the end of the battery housing and receive fixing screws through the screw holes at the end of the battery housing into the plurality of screw holes 402, 404 of the end cap housing 102.

The end cap housing 102 may comprise a plurality of channels 406, 408 located from each of the plurality of screw holes 402, 404 of the end cap housing 102 to an outer edge of the end cap housing 102. The channels 406, 408 may be configured to receive recessed portions of the housing within which the corresponding plurality of screw holes at the end of the battery housing are located, thereby allowing for assembly of the end cap in the battery housing by sliding the recessed portions of the housing along the corresponding plurality of channels 406, 408 of the end cap housing 102 until the plurality of screw holes of the end cap housing 402, 404 align with the corresponding plurality of screw holes at the end of the battery housing.

The plurality of channels 406, 408 may comprises a first channel 406 in a first orientation; and a second channel 408 in a second orientation different to the first orientation. In some examples, the battery housing to which the end cap is to be affixed (via the end cap housing 102) may comprise two portions, a first lower portion, and a second upper portion. The first and second portions may be, for example, square-C shaped half-pipes or channels which, when fitted together, form a (e.g. rectangular cross-sectional) space therebetween in which the battery cells may be located. The first channel 406 may be configured to accept a portion (e.g. a first lower portion) of the battery housing slid onto the end cap along a first direction with respect to the end cap (in FIG. 4, the first direction is along the z direction, in the plane of the upright portion 102a). The second channel 408 may be configured to accept a second portion (e.g. the second upper portion) of the battery housing slid onto the end cap along a second direction with respect to the end cap. In FIG. 4, the second direction is along the x direction, co-planar with the bottom portion 102b. The first and second channels 406, 408 may be configured to allow the first and second portions of the battery housing to meet after being slid onto the end cap (end cap housing 102) to form a battery and end cap assembly. Or, if electrical cells and associated connections are present within the housing, a battery module may be formed. After meeting, the first and second portions of the battery housing may be fastened together, for example by welding.

By “receive a portion of a battery housing”, for example, it is meant that the battery housing portion may be slotted onto the end cap housing 102. In other words, the end cap housing may be slotted into the housing. The housing may comprise indentations located and configured to each correspond with a respective channel of the end cap housing allowing the housing and end cap housing to be slotted together. Such indentations may be, for example, recessed fixture holes (e.g. screw holes) in the housing which are configured to align with the screw holes 402, 404 in the end cap housing and used to affix the housing to the end cap housing 102. Because the end cap housing 102 is configured to allow first and second portions of the housing to be slotted onto it from different directions, the structural stability of the overall battery module is improved, since a force acting to push the overall housing (i.e. connected first and second portions) away from the end cap housing in a direction parallel to one set of channels 406, 408, is prevented from moving the housing in that direction by the other set of channels 408, 406 which do not permit the housing to be moved with respect to the end cap housing in the same direction. For example, from the viewpoint of FIG. 4, a bottom housing portion would slot onto the end cap housing 102 from underneath (in the z direction) via channels 406, whereas a top housing portion would slot onto the end cap housing 102 from the left (in the x direction) via channels 404. Thus a force on the housing downwards (−z direction) is prevented from moving the housing with respect to the end cap housing by the upper channels 404, and likewise, a force on the housing leftwards (−x direction) is prevented from moving the housing with respect to the end cap housing by the lower channels 406.

The end cap housing, 102, as part of a battery module, is configured to be rigidly fixed to a structural component of a vehicle, thereby securing the battery module to the vehicle. Overall, a plurality of electrically connected battery modules, or in some examples, one battery module, may be called a battery pack.

FIG. 5 shows an example end cap 500 having an end cap housing 102, heat staked busbar connector housing 104, and two busbar connectors 106 housed therein. The busbar connector housing 104 may be fixed, as shown, in the end cap housing 102 by a plurality of posts 508 of the busbar connector housing 104 located in a corresponding plurality of postholes 510 in the end cap housing. Each post 508 may be heat staked to fix it in position in its corresponding posthole 510. Such an arrangement of busbar connector housing posts 508 and corresponding end cap housing postholes 510 and the ability to heat stake the posts 508 in the postholes 510 provides an easy method for securely fixing the end cap housing 102 and busbar connector housing 104 together.

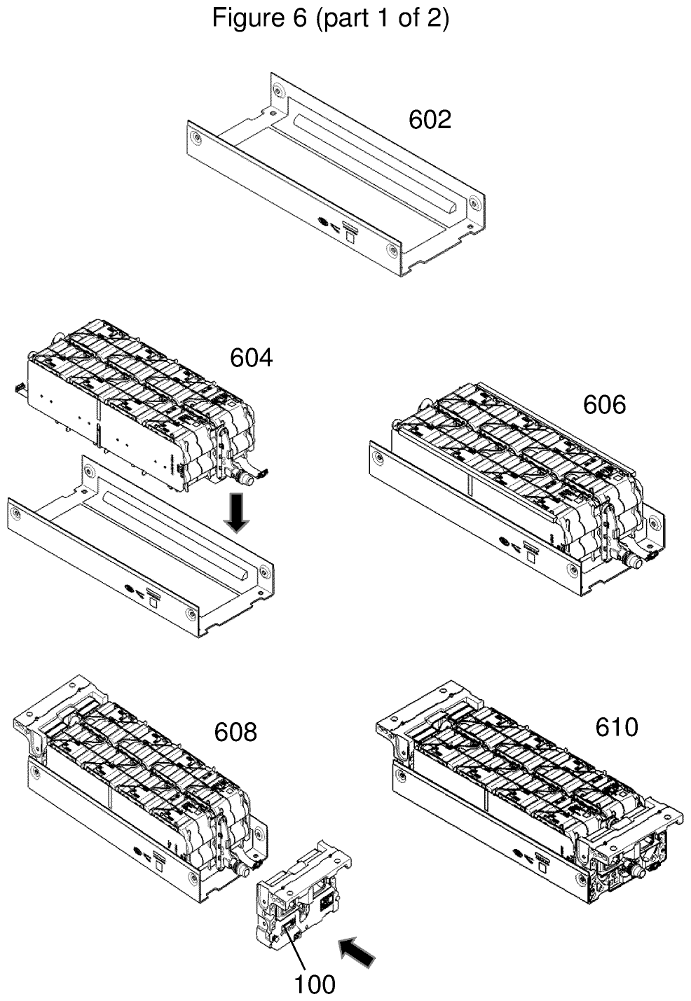

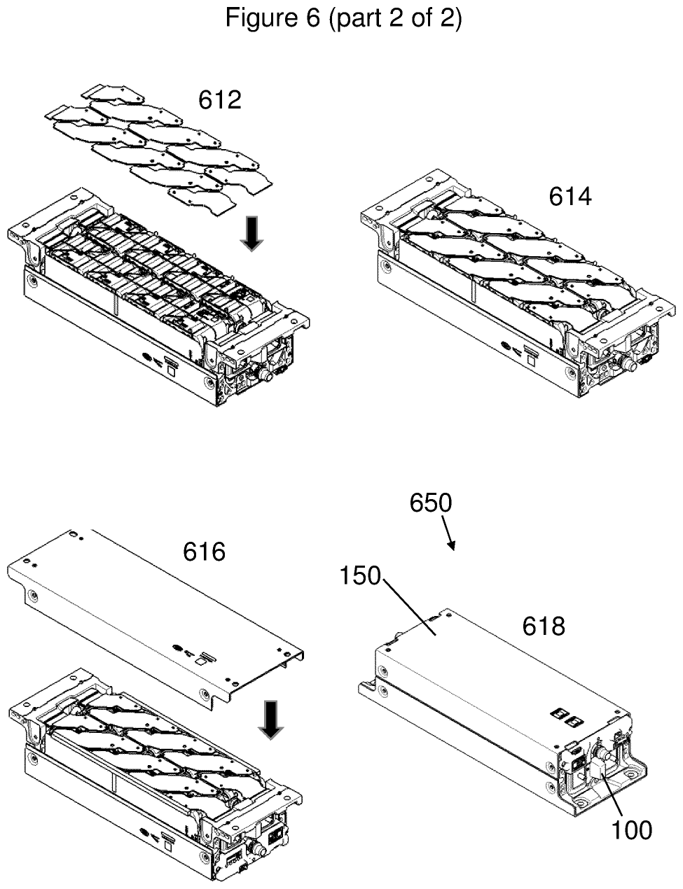

FIG. 6 shows an example of a schematic flow of assembly of an example battery module 650. The battery module 650 comprises an end cap 100 as disclosed herein (in this example two end caps are used, one at each end of the battery module); a housing 150, wherein the end cap is located at an end portion of the housing; and a battery within the housing. A module busbar of the battery is electrically connected inside the housing to the busbar connector of the end cap housing. A battery pack may be provided by an electrically connected plurality of such battery modules. The steps illustrated in FIG. 6 are as follows:
602—A housing upper portion is provided.
604, 606—A battery, e.g. a battery supercell (a plurality of connected battery modules) is provided and located within the housing upper portion.
608, 610—An end cap 100 is provided and located at each end of the battery. It is shown that the end cap 100 slides to connect with the housing upper portion in a direction along the length of the housing, i.e. right to left as shown.
612, 614—A module busbar is provided and located on the battery and (e.g. laser) welded to the end cap busbar connectors (e.g. to the bottom portion 108b as discussed in relation to FIGS. 3a-3c).
616, 618—A housing lower portion is provided and located to form a complete housing with the housing upper portion, housing the battery. It is shown that the end cap 100 slides to connect with the housing upper portion in a direction perpendicular to the length of the housing, i.e. top down as shown.

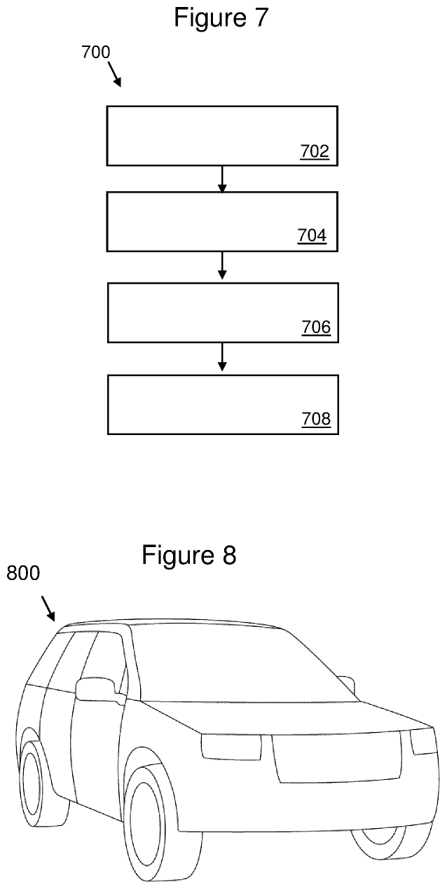

FIG. 7 shows a method 700 of forming an end cap for a traction battery housing of an electric vehicle. The method 700 comprises forming an electrically conductive busbar connector 702. The busbar connector is configured to connect to a module busbar of a traction battery within a traction battery housing and provide a terminal outside the traction battery housing to allow for electrical connection to the module busbar. The method comprises forming an electrically insulating busbar connector housing with the busbar connection fixed therein 704. The method 700 also comprises forming a rigid, electrically conductive, end cap housing 706. The end cap housing is configured to be located at and connect to an end of a traction battery housing. The method 700 also comprises fitting the busbar connector housing and busbar connector fixed therein into the end cap housing 708. The busbar connector housing electrically isolates the busbar connector from the end cap housing.

Forming an electrically insulating busbar connector housing around the busbar 704 in some examples may comprise overmoulding electrically insulating material around an outer edge of the busbar connector to form the inner plate portion and the outer plate portion; and setting the electrically insulating material to rigidly fix the busbar connector in position in the busbar connector housing. The overmoulding process may comprise injection moulding.

Forming an electrically insulating busbar connector housing around the busbar connector 104 in some examples may comprise: forming a first housing plate providing an inner plate portion of the busbar connector housing; forming a second housing plate providing an outer plate portion of the busbar connector housing; locating the busbar connector between the first and second housing plates; and fastening together the first and second housing plates with the busbar connector sandwiched therebetween to rigidly fix the busbar connector in position in the busbar connector housing.

Fitting the busbar connector housing and module busbar connected housed therein into the end cap housing 708 in some examples may comprise: locating a plurality of posts of the busbar connector housing in a corresponding plurality of postholes in the end cap housing; and heat staking the plurality of posts to fix them in position in their corresponding posthole.

It will be appreciated that certain examples disclosed herein can be realised in the form of hardware, software or a combination of hardware and software; for example software to control a control system to perform at least a part of a method as discussed above e.g. in an automated or semi-automated process. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. Such software may comprise computer readable code stored on a non-transitory computer-readable storage medium. It will be appreciated that the storage devices and storage media are embodiments of machine-readable storage that are suitable for storing a program or programs that, when executed, implement embodiments disclosed herein. Accordingly, embodiments provide a program comprising code for implementing a system or method as claimed in any preceding claim and a machine readable storage storing such a program. Still further, embodiments disclosed herein may be conveyed electronically via any medium such as a communication signal carried over a wired or wireless connection and embodiments suitably encompass the same.

FIG. 8 shows an example vehicle 800 comprising any end cap 100 disclosed herein, any battery module 600 disclosed herein, or any battery pack disclosed herein.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. An end cap for a battery module housing of an electric vehicle, the end cap comprising:
an electrically conductive end cap housing, the end cap housing configured to connect to an end of a traction battery housing;
an electrically insulating busbar connector housing fixed within the end cap housing; and
an electrically conductive busbar connector fixed within the busbar connector housing, the busbar connector housing configured to electrically isolate the busbar connector from the end cap housing, the busbar connector configured to connect to a module busbar of a battery module inside the battery module housing and provide a terminal outside the battery module housing to allow for electrical connection to the module busbar, wherein
the busbar connector housing comprises an overmoulded housing formed by moulding electrically insulating material around an outer edge of the busbar connector, thereby, once the electrically insulating material is set, rigidly fixing the busbar connector in position in the busbar connector housing.

2. (canceled)

3. (canceled)

4. The end cap of claim 1, wherein the busbar connector housing is fixed in the end cap housing by a plurality of posts of the busbar connector housing located in a corresponding plurality of postholes in the end cap housing.

5. The end cap of claim 1, comprising a plurality of electrically conductive busbar connectors fixed in the busbar connector housing, the busbar connector housing configured to electrically isolate the plurality of busbar connectors from each other and from the end cap housing.

6. The end cap of claim 1, wherein the busbar connector housing is formed from plastic.

7. The end cap of claim 1, wherein the end cap housing is formed of metal.

8. The end cap of claim 1, wherein the busbar connector comprises a metal plate configured to be fixed in the busbar connector housing, and a stud protruding from the metal plate configured to provide the terminal outside the traction battery housing to allow for electrical connection to the module busbar.

9. The end cap of claim 1, wherein
the end cap housing comprises a plurality of screw holes located to align with a corresponding plurality of screw holes at the end of a traction battery housing, and
the end cap is configured to connect to the end of the traction battery housing by being slotted at least partially into the end of the traction battery housing and receive fixing screws through the screw holes at the end of a traction battery housing into the plurality of screw holes of the end cap housing.

10. The end cap of claim 9, wherein the end cap housing comprises a plurality of channels located from each of the plurality of screw holes of the end cap housing to an outer edge of the end cap housing;
wherein the channels are configured to receive recessed portions of the housing within which the corresponding plurality of screw holes at the end of the traction battery housing are located,
thereby allowing for assembly of the end cap in the traction battery housing by sliding the recessed portions of the housing along the corresponding plurality of channels of the end cap housing until the plurality of screw holes of the end cap housing align with the corresponding plurality of screw holes at the end of the traction battery housing.

11. The end cap of claim 9, wherein the plurality of channels comprises:
a first channel in a first orientation; and
a second channel in a second orientation different to the first orientation;
the first channel configured to accept a portion of the traction battery housing slid onto the end cap along a first direction with respect to the end cap; and
the second channel configured to accept a second portion of the traction battery housing slid onto the end cap along a second direction with respect to the end cap,
the first and second channels configured to allow the first and second portions of the traction battery housing to meet after being slid onto the end cap to form a traction battery and end cap assembly.

12. A battery module for an electric vehicle, the battery assembly comprising:
the end cap of claim 1;
a housing, wherein the end cap is located at an end portion of the housing; and
a battery within the housing, wherein a module busbar of the battery is electrically connected inside the housing to the busbar connector.

13. A battery pack comprising a plurality of battery modules of claim 12.

14. A vehicle comprising the end cap of claim 1.

15. A method of forming an end cap for a traction battery housing of an electric vehicle, the method comprising:
forming an electrically conductive busbar connector, the busbar connector configured to connect to a module busbar of a traction battery within a traction battery housing and provide a terminal outside the traction battery housing to allow for electrical connection to the module busbar;
forming an electrically insulating busbar connector housing with the busbar connection fixed therein;
forming a rigid, electrically conductive, end cap housing, the end cap housing configured to be located at and connect to an end of a traction battery housing; and
fitting the busbar connector housing and busbar connector fixed therein into the end cap housing; the busbar connector housing electrically isolating the busbar connector from the end cap housing wherein
forming an electrically insulating busbar connector housing comprises forming anelectrically insulating busbar connector around the busbar connector by:
overmoulding electrically insulating material around an outer edge of the busbar connector to form the inner plate portion and the outer plate portion; and
setting the electrically insulating material to rigidly fix the busbar connector in position in the busbar connector housing.

16. (canceled)

17. (canceled)

18. The method of claim 15, wherein fitting the busbar connector housing and module busbar connected housed therein into the end cap housing comprises:
locating a plurality of posts of the busbar connector housing in a corresponding plurality of postholes in the end cap housing; and
heatstaking the plurality of posts to fix them in position in their corresponding posthole.

19. The end cap of claim 6, wherein the busbar connector housing is formed of glass fibre filled polypropylene.

20. The end cap of claim 7, wherein the end cap housing is formed of aluminium.

21. The end cap of claim 8, wherein the metal plate comprises aluminium.

22. The end cap of claim 8, wherein the stud comprises steel.
